(19) United States
(12) Patent Application Publication
(10) Pub. No.: US 2024/0170976 A1
(43) Pub. Date: May 23, 2024

(54) BATTERY MANAGEMENT SYSTEM WITH BATTERY CURRENT CONTROL FOR PARALLEL BATTERIES

(71) Applicants: Mohammed Alobaidi, Kokomo, IN (US); Nicola Cinagrossi, Uster (CH); Jochen Schumann, USter (CH)

(72) Inventors: Mohammed Alobaidi, Kokomo, IN (US); Nicola Cinagrossi, Uster (CH); Jochen Schumann, USter (CH)

(73) Assignee: Green Cubes Technology, LLC, Kokomo, IN (US)

(21) Appl. No.: 18/282,892

(22) PCT Filed: Mar. 23, 2021
(86) PCT No.: PCT/US2021/023682

§ 371 Date: Sep. 19, 2023

(51) Int. Cl. H02J 7/00; H02J 7/34

(52) U.S. Cl. CPC H02J 7/0016; H02J 7/0045; H02J 7/00712; H02J 7/342

(57) ABSTRACT

Disclosed herein are different charging stations, systems, and methods for recharging swappable or non-swappable batteries having differing states of health, impedance, age, etc. Swappable and non-swappable battery packs may be charged in parallel, but the amount of charge current supplied to each parallel battery pack is determined individually by the battery pack itself. Each battery may have its own maximum charge and/or discharge current limits set individually to avoid using a battery pack over its rating, provide voltage equalization, and control energy flow among the plurality of rechargeable battery packs. This also extends the operating lifetime of older battery packs. In a charging mode, a battery charger may set a floating voltage and each battery pack may take its own current to provide voltage equalization. Additionally, a battery pack can boost its own voltage to maintain the required voltage level by a particular load/application.

### BACKGROUND

In the last decade, the use of battery packs has increased in many areas such as datacenter, telecom, sweepers, cleaning machines, agricultural equipment, construction equipment, marine equipment, and battery powered vehicles, just to name a few. Most of the battery powered equipment uses more than one battery pack in parallel or more than one battery for each piece of equipment. These battery packs may have different impedances due to several factors like different cells, different aging, different temperature etc., so charging these batteries in the same charger or discharging them in parallel in their equipment leads to higher current withdrawn from the lower impedance pack which will lower the lifetime for that battery. This issue can be mitigated by controlling the max charging & discharging current for each battery pack from the battery pack's Battery Management System (BMS).

Using a BMS having a battery current control for parallel batteries may have many benefits. It can allow a user to use many batteries, each having a different impedance, in parallel without worrying about exceeding the battery rating. This is because the peak current for each battery pack will be limited in the battery pack itself without hard disconnections (the battery pack will just deliver its max current in constant current mode). Moreover, the number of charging/discharging cycles for old battery packs can be reduced to increase their operating lifetime. The ability to control the current in the battery pack can be utilized to further limit their charging current based on the State of Health (SoH) of the battery pack. With this strategy, newer batteries will have higher number of cycles with respect to old batteries. The lifetime of old batteries will be therefore extended, and capital expenditure investments may be delayed.

In the parallel battery packs, the power flow among the battery packs may be controlled by controlling the max charging current. The battery pack with lower, or the lowest, voltage may be charged automatically by the other battery packs in parallel thus achieving voltage equalization across all battery packs in parallel without risk of tripping the overcurrent protections in the battery packs (fuse, contactors, switches, etc.). Moreover, hot plug of battery packs can be easily achieved because the inrush-current is automatically limited both in charging or in discharging mode. The battery packs can be replaced manually or by a robot. In the case of a robot, an exemplary robot art may the discharged battery from the equipment and replace it with the fully charged one.

Additionally, in the parallel battery packs, the charging station hardware may be also simplified. The battery charging station is only required to control the float voltage of the battery packs, and not the charging current, which can be placed directly in parallel. Thus, the battery packs may be controlled independently of their charging current. The battery charger controller may communicate with the BMS in the battery packs and set their charging current limit. If the BMS does not include communication between the battery charging station and battery packs, the charging current limit can be set by default in each battery pack.

It would thus be desirable to have a BMS having a battery current control for parallel battery packs wherein the battery packs have the ability to boost their output voltage to meet the load voltage at all times.

### BRIEF SUMMARY OF THE INVENTION

The present disclosure includes disclosure of a swappable battery charging system, comprising: a battery charging station having multiple battery charging ports, each battery charging port of the multiple battery charging ports configured to releasably receive a rechargeable battery pack therein; at least one rechargeable battery pack positioned within at least one battery charging port of the battery charging station and connected in parallel to at least one other rechargeable battery pack positioned within at least one other battery charging port of the battery charging station; and wherein the at least one rechargeable battery pack has its own battery management system and can independently control its own charging and discharging limits.

The present disclosure also includes disclosure of the system, wherein the at least one other rechargeable battery pack has its own battery management system and can also independently control its own charging and discharging limits.

The present disclosure also includes disclosure of the system, wherein the swappable battery charging system is used in datacenters, telecom, sweepers, cleaning machines, agricultural equipment, construction equipment, marine equipment, or battery powered vehicles.

The present disclosure also includes disclosure of the system, wherein the at least one rechargeable battery pack independently controls its maximum charging and discharging limits based upon a state of health or temperature, to extend its own operating life.

The present disclosure also includes disclosure of the system, wherein the at least one rechargeable battery pack independently controls its maximum charging and discharging limits based upon impedance or current to avoid operating above its battery rating.

The present disclosure also includes disclosure of the system, wherein the at least one rechargeable battery pack independently controls its maximum charging and discharging limits to control energy flow exchanged in parallel between itself at the at least one other rechargeable battery pack to achieve voltage equalization.

The present disclosure also includes disclosure of the system, wherein the at least one rechargeable battery pack has a circuit to boost voltage to maintain an acceptable voltage level during high load applications, or when a voltage level is not sufficient to meet the high load application's voltage requirement.

The present disclosure also includes disclosure of the system, wherein the battery charging station controls float voltage of the at least one rechargeable battery pack, and wherein the at least one rechargeable battery pack independently controls its own charging current.

The present disclosure also includes disclosure of the system, further comprising a system selected from the group consisting of a computer, Wi-Fi, Bluetooth Low Energy (BLE), a GPS, and an artificial intelligence hub in operable communication therewith.

The present disclosure also includes disclosure of the system, further comprising at least one of a display, monitor, or another visual indicator to provide real time information on a charge level of the at least one rechargeable battery pack, a location of particular battery packs, and other battery pack health or status information.

The present disclosure also includes disclosure of the system, wherein each of the at least one rechargeable battery packs can be swapped manually or by a remote-controlled charger using a robotic arm.

The present disclosure also includes disclosure of the system, wherein each of the at least one rechargeable battery packs can be charged by a remote-controlled charger or by the battery charging station.

The present disclosure also includes disclosure of the system, wherein the battery charging station is coupled to a power source.

The present disclosure also includes disclosure of a non-swappable battery charging system, comprising: a plurality of battery packs connected in parallel having same or different capacity, wherein each battery pack of the plurality of battery packs has its own battery management system to independently control its own charging and discharging limits; and a battery charger operably coupled to a power source and at least one battery pack of the plurality of battery packs, wherein the battery charger is configured to charge the plurality of battery packs and to control a float voltage of the plurality of battery packs to charge the plurality of battery packs in parallel.

The present disclosure also includes disclosure of the system, further comprising a cabinet sized to receive the non-swappable battery charging system having the plurality of rechargeable battery packs therein.

The present disclosure also includes disclosure of the system, configured for use in at least one of a datacenter, telecom, or a back-up power application.

The present disclosure also includes disclosure of the system, wherein each battery pack of the plurality of battery packs can control its maximum charging and discharging limits based upon a state of health or temperature, to extend its operating life.

The present disclosure also includes disclosure of the system, wherein each battery pack of the plurality of battery packs independently controls its maximum charging and discharging limits based upon impedance to avoid operating above its own battery rating.

The present disclosure also includes disclosure of the system, wherein each battery pack of the plurality of battery packs independently controls its maximum charging and discharging limits to control exchanged energy flow to achieve voltage equalization across the plurality of battery packs in parallel.

The present disclosure also includes disclosure of the system, wherein each battery pack of the plurality of battery packs has a circuit to boost voltage to maintain an acceptable voltage level during high load applications, or when a voltage level is not sufficient to meet the high load application's voltage requirement.

The present disclosure also includes disclosure of the system, wherein each of the plurality of battery packs independently controls its own charging current.

The present disclosure also includes disclosure of the system, further comprising a system selected from the group consisting of a computer, Wi-Fi, Bluetooth Low Energy (BLE), a GPS, and an artificial intelligence hub operably coupled therewith.

The present disclosure also includes disclosure of the system, further comprising at least one of a display, a monitor, or another visual indicator to provide real time information on a charge level of each of the plurality of battery packs, a location of particular battery packs, and other battery pack health or status information.

The present disclosure also includes disclosure of a method for charging or discharging batteries, comprising: coupling a plurality of rechargeable battery packs together in parallel; determining which of the plurality of rechargeable battery packs has either a lowest impedance or voltage, or a highest impedance or voltage; and setting a charging strategy for each of the plurality of rechargeable battery packs individually to control maximum charging and discharging limits for at least one particular rechargeable battery pack of the plurality of the rechargeable battery packs to extend its operating life, and to provide voltage equalization and control energy flow among the plurality of rechargeable battery packs.

The present disclosure also includes disclosure of the method, further comprising setting a float voltage for each of the plurality of rechargeable battery packs individually.

The present disclosure also includes disclosure of the method, further comprising determining an age, temperature, or state of health (SoH) for each of the plurality of rechargeable battery packs.

The present disclosure also includes disclosure of the method, wherein each battery pack of the plurality of rechargeable battery packs shares different amounts of current and delivers its max current in a constant supply.

The present disclosure also includes disclosure of the method, wherein discharge current of the at least one particular rechargeable battery pack is limited to a value which is different than that of other battery packs of the plurality of the rechargeable battery packs to avoid depleting the at least one particular rechargeable battery pack over its rating.

The present disclosure also includes disclosure of the method, wherein setting a charging strategy for each of the plurality of rechargeable battery packs individually simplifies a charging circuit and hardware requirements.

The present disclosure also includes disclosure of the method, wherein a battery pack of the plurality of the rechargeable battery packs having a lowest voltage automatically receives maximum charging current from other rechargeable battery packs of the plurality of the rechargeable battery packs to control exchanged energy flow.

The present disclosure also includes disclosure of a power module sized to receive a plurality of swappable rechargeable battery packs therein, wherein the plurality of swappable rechargeable battery packs are connected in parallel, and wherein each of the plurality of swappable rechargeable battery packs has its own battery management system to independently control its own charging and discharging limits.

The present disclosure also includes disclosure of the power module, wherein the plurality of swappable rechargeable battery packs are modular.

The present disclosure also includes disclosure of the power module, wherein the plurality of swappable rechargeable battery packs are removed and replaced by a robot, wherein the robot has its own battery charger therein and an arm for removing and replacing the plurality of swappable rechargeable battery packs.

The present disclosure also includes disclosure of the power module, wherein the robot having its own battery charger therein further comprises its own internal battery to be charged by a dock in charger or by any of the plurality of swappable rechargeable battery packs.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of the present disclosure taken in conjunction with the accompanying drawings, wherein:

FIG. 1 illustrates a perspective view of an exemplary embodiment of a battery charging station with swappable rechargeable battery packs;

FIG. 2 illustrates an exemplary schematic of parallel swappable rechargeable battery packs having different impedance with the max discharge limit for the lower impedance battery pack;

FIG. 3 illustrates an exemplary graph of limiting the max charging and discharging current of battery packs (swappable and non-swappable) to increase the life of old battery packs;

FIG. 4 illustrates an exemplary schematic for voltage equalization across parallel battery packs and the max charge limit for a lower voltage battery pack;

FIG. 5 illustrates an exemplary schematic of the battery charging station using battery pack current control;

FIG. 6 illustrates a perspective view of an exemplary embodiment of swappable battery packs for Telecom BBU and data centers;

FIG. 7 illustrates a perspective view of an exemplary embodiment of a battery charging station having a remote-controlled charger with robot arm;

FIG. 8 illustrates a perspective view of an exemplary embodiment of non-swappable battery packs;

FIG. 9 illustrates an exemplary schematic diagram of non-swappable battery packs within a Telecom BBU system embodiment; and

FIG. 10 illustrates an exemplary battery charging system for material handling equipment wherein individual non-swappable paralleled battery packs may increase energy rating in the system.

As such, an overview of the features, functions and/or configurations of the components depicted in the figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding the principles of the present disclosure, reference will now be made to the embodiments illustrated in the drawings, and specific language will be used to describe the same. It will nevertheless be understood that no limitation of the scope of this disclosure is thereby intended.

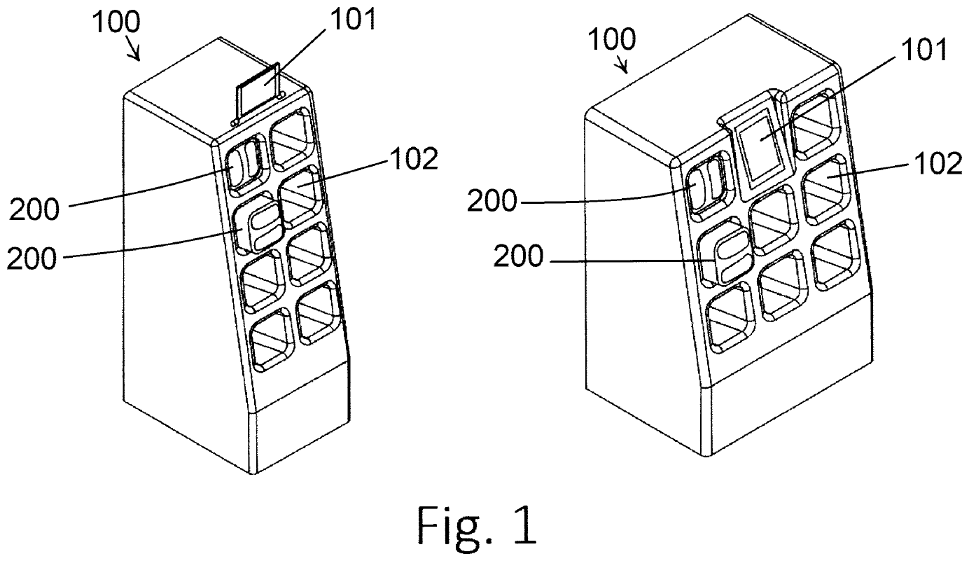

As shown in FIG. 1, the present disclosure includes an exemplary battery charging station 100 (also called a “charger” or “battery charger” herein) such as may be used to charge one, or a plurality, of rechargeable swappable battery packs 200 (also called “battery,” “batteries,” and/or “battery pack(s)” herein). The battery charging station 100 may have a variety of different design geometries, such as a cabinet or tower structure. The battery charging station 100 may further include a display 101, such as a touch screen, computer, monitor, or other visual indicator of the health and/or charging status of the battery packs 200 as shown in FIG. 1. The battery charging station 100 may also be operably coupled to a power source and/or load for charging one and/or a plurality of swappable battery packs 200, and for powering display 101.

Also shown in FIG. 1, the battery charging station 100 may also have a plurality of openings, docks, grooves, slots, or ports 102, wherein each of the ports 102 may be in operable and/or electrical communication with each other and/or computer. Each of the ports 102 may be sized to releasably receive a rechargeable swappable battery pack 200 therein. The rechargeable swappable battery packs 200 used may have the same, or varying, chemistry, age, impedance, temperature, state of health (SoH), etc. Each of the rechargeable swappable battery packs 200 may be in operable and/or electrical communication with each other and may comprise its own independently controlled battery management system (BMS). In another embodiment, the rechargeable swappable battery packs 200 may be in operable and/or electrical communication with a BMS. The battery charging station 100 and/or swappable rechargeable battery packs 200 may be used in various industries and/or applications, such as in datacenters, Telecom BBU, sweepers, cleaning machines, agricultural equipment, construction equipment, marine equipment, and battery powered vehicles, just to name a few examples.

Using multiple battery packs 200 in parallel has previously presented several challenges. Often, one or more battery packs 200 can have a lower impedance that the others due to aging, different temperatures, and/or different cells, which has led to over-use of some of the battery packs 200 (more than the others), which then reduces the overall battery pack 200 lifetime. However, by adding the BMS to each battery pack 200 and thus, controlling the maximum charging current 201 individually in each of the battery packs 200, many of these previous challenges may be solved. Connecting the battery packs 200 in parallel, while still allowing each battery pack 200 to independently control its own charging and discharging limits (via its own BMS), may extend the lifetime of old batteries, provide voltage equalization, simplify the charging circuit, and simplify hardware requirements.

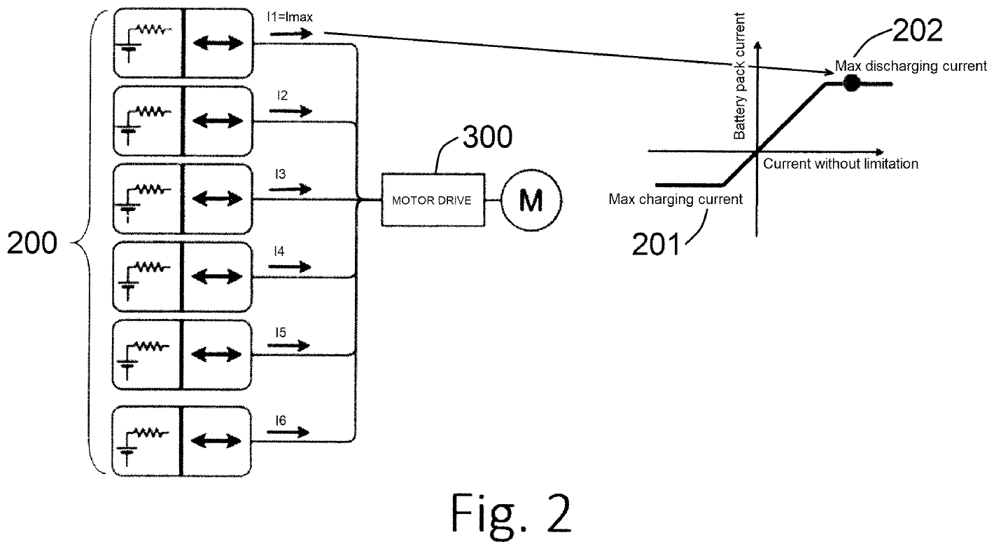

FIG. 2 illustrates multiple battery packs 200, each having its own BMS, and connected in parallel to a motor drive/load 300. Within FIG. 2, the top (R1) battery pack 200 has a lower impedance (shown as R1), and thus a higher current that that of the other battery packs 200. In this embodiment, Imax represents the maximum discharge current 202, wherein the maximum discharge current may be capped at Imax 202. In this way, the discharging current 202 may be limited to a value which is different than that of the other battery packs 200 (connected in parallel) to avoid depleting the top (R1) battery pack 200 above or over its rating. Each battery pack 200 may have its own BMS to control its own limit and/or rating and may share different amounts of current without tuning off and/or going over its rating. Each battery pack 200 may also deliver its max current in constant current mode.

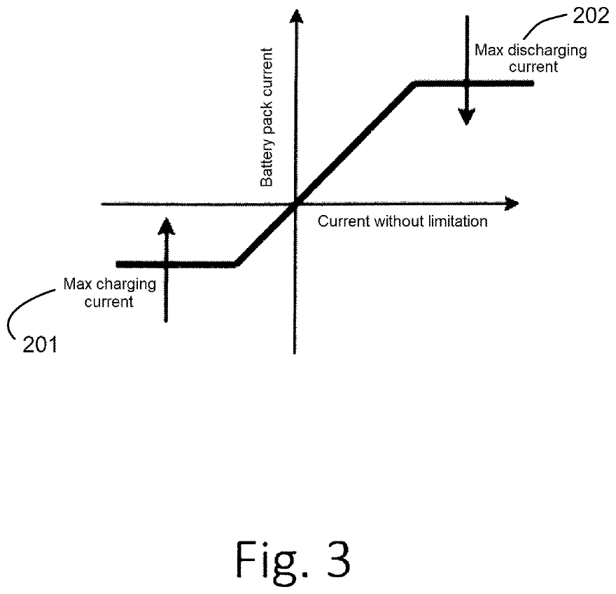

Additionally, by having these BMS control(s) independently within each battery pack 200, the operating lifetime of an older battery pack may be extended by limiting charge 201 and discharge 202 cycles and limits. In one embodiment, this may be done by reducing the max charging 201 and discharging 202 limits for the older, or oldest, battery packs 200, such as shown in FIG. 3. This method of reducing the max charging and discharging cycles and/or limits for particular battery packs 200 may be used for both swappable and non-swappable rechargeable battery packs 200/700 (as will be described herein below). In this way, the newest battery packs 200 may be used more heavily than the older battery packs 200 to extend the life of the older battery packs 200, thus extending the lifetime of older battery packs 200 and reducing capital expenditures.

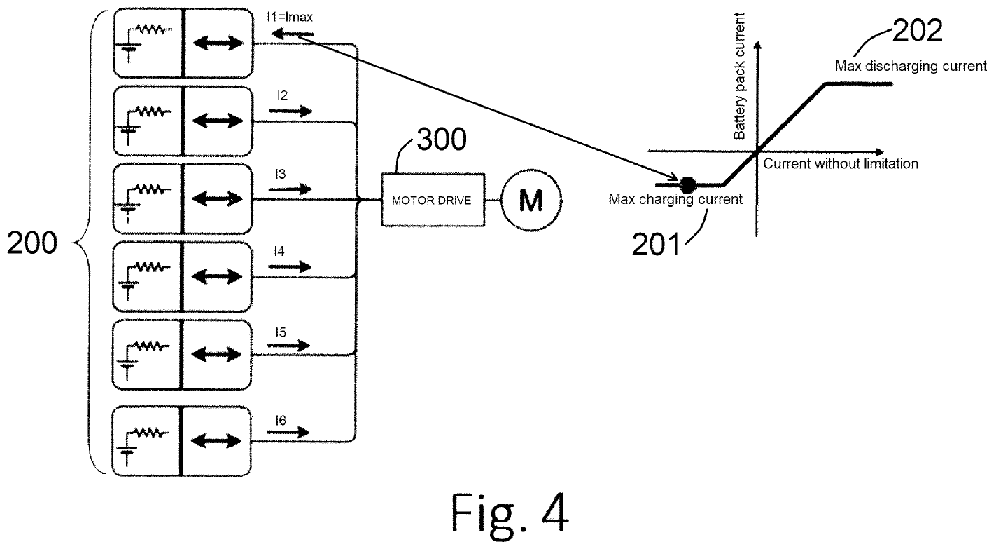

With reference now to FIG. 4, parallel battery packs 200 having different states of charge (SoC) and voltage may be used to deliver power to the load/motor 300, as well as to provide voltage equalization among the battery packs 200. For example, the battery pack 200 with the lower, or lowest, voltage, shown as 11=Imax, wherein Imax represents the maximum charging current 201, will automatically receive the maximum charging current 201 from the other battery packs 200 in parallel. In this way, the exchanged energy flow may be controlled by adjusting the max charging current 201 of the battery packs 200 in parallel.

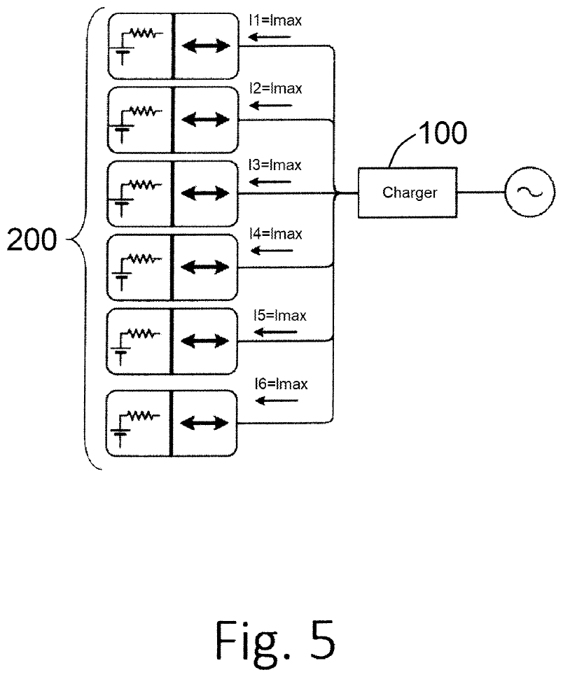

FIG. 5 illustrates an exemplary battery charging station 100 connected to several battery packs 200 in parallel, such as by using a common power bus. In this embodiment, the charging station 100 may set the float or floating voltage for each of the battery packs 200. However, the charging strategy for each battery pack 200 may still be controlled individually via the BMS, such that each battery pack 200 may have its own charging current based on different parameters such as state of health (SoH), impedance, temperature, age, etc. The charging limit for each battery pack 200 may be set by an external controller via communication bus to the battery pack's 200 BMS. In other embodiments, where the batter pack 200 has no communication with a charger 100, the current limit may be set internally by the BMS itself.

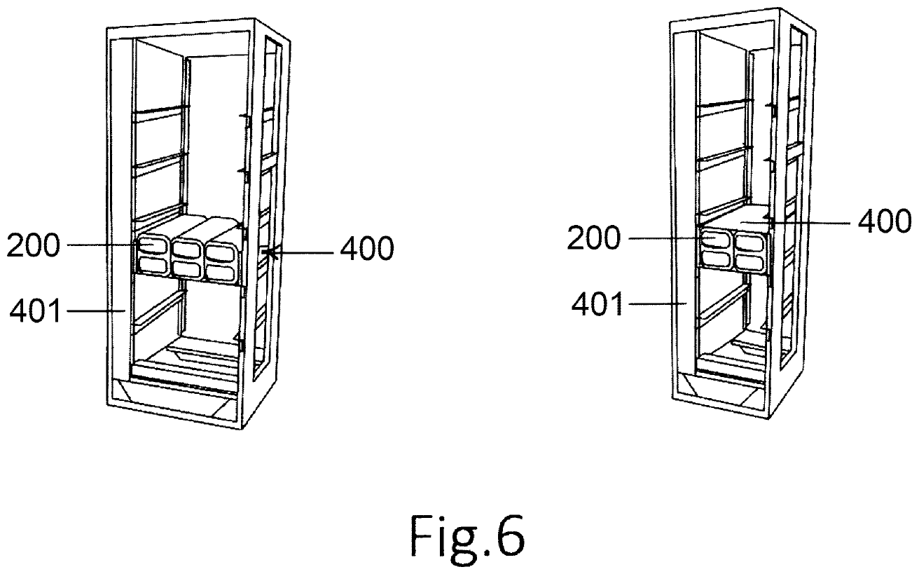

FIG. 6 illustrates another potential embodiment of a power module 400 having multiple rechargeable and swappable battery packs 200 inserted therein and connected in parallel. In this embodiment, the power module 400 may be installed inside a 19-inch or 23-inch sized standard rack inside of a cabinet 401, for example. The power module 400 may include a plurality of modular, swappable, rechargeable battery packs 200 therein, as shown in FIG. 6. The power module 400 may provide power to different equipment in a data center and/or telecom central office, for example.

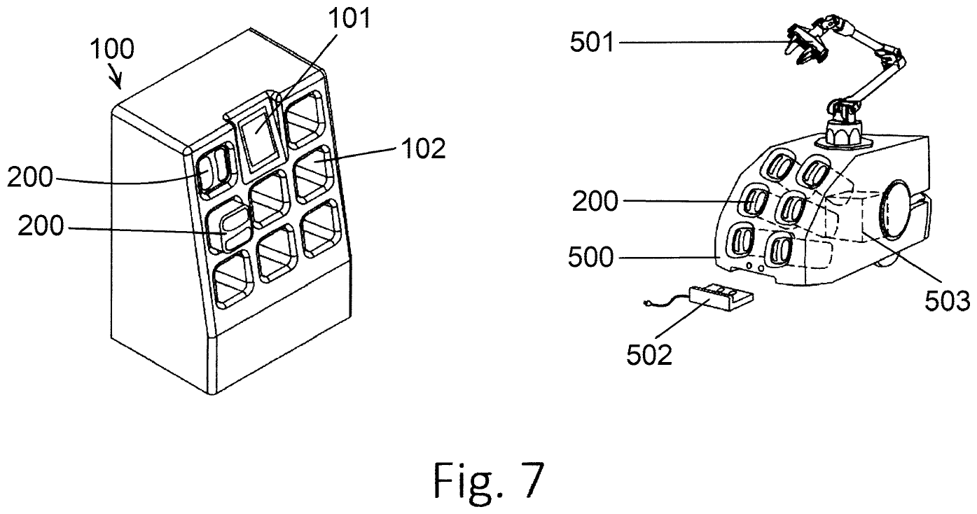

Additionally, in some embodiments, the battery packs 200 may be replaced manually by staff, and/or automatically using a remote-controlled battery swapper 500, as shown in FIG. 7. With reference now to FIG. 7, the remote-controlled battery swapper 500 may include and/or be coupled to a robot arm 501 to remove, replace, and/or insert the swappable battery packs 200 into/from the openings or ports 102 of a battery charging station 100 and/or power module 400 and/or other devices or vehicles. In one embodiment, the robot arm 501 may remove the discharged battery pack 200 from the power module 400, and then replace it with a fully charged battery pack 200. Additionally, the remote-controlled battery swapper 500 may also include its own battery charger to charge the battery packs 200 using ports, docks, slots, or openings 502 within the battery swapper 500 itself. In some embodiments, the remote-controlled battery swapper 500 may also include an internal battery 503 to power itself. Additionally, the internal battery 503 itself may be charged using the swappable battery packs 200 and/or the dock within the charger 502.

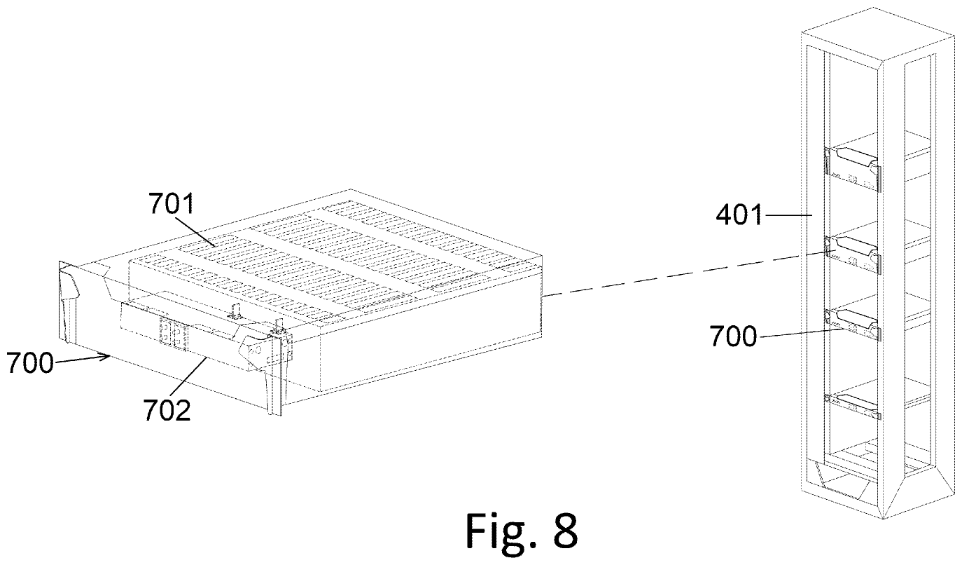

In another embodiment, shown in FIG. 8, non-swappable rechargeable battery packs 700 may be utilized in parallel as described herein above, except that these non-swappable battery packs 700 may simply be charged in place (i.e., without removal for recharging). The battery packs 700 may still each have its own BMS and may be placed and/or charged in parallel with the charge and discharge current independently controlled by the BMS within each battery pack 700 itself.

FIG. 8 shows a non-swappable battery pack 700 installed in a 19-inch or 23-inch sized standard rack inside a cabinet 401. In this embodiment, the non-swappable rechargeable battery packs 700 may, for example, be used inside cabinets 401 for Telecom BBUs and/or in data centers for back-up power. In these embodiments, several battery packs 700 may be connected in parallel, even if they have different capacities, because the current charged and/or discharged from each battery pack 700 may be controlled separately.

As shown in FIG. 8, the non-swappable battery packs 700 may include battery cells 701 and a charge/discharge box 702. In this embodiment, the charge/discharge box 702 may receive different measurements such as voltage, current, power, temperatures, SoC, SoH, fan speed etc. The charge/discharge box 702 may then control the battery pack's 700 charge and/or discharge activities and limits based upon the different measurements received. The charge/discharge box 702 may limit the maximum charging current 201 and the maximum discharging current 202 (shown in FIG. 3) based on the different measurements received and/or preprogrammed or predetermined parameters. Moreover, when the battery pack 700 voltage is low at the end of discharge, or when the load is high causing the battery pack 700 voltage to go under the accepted limit, the charge/discharge box 702 can boost the battery pack's 700 voltage to maintain a stable voltage supply to the load.

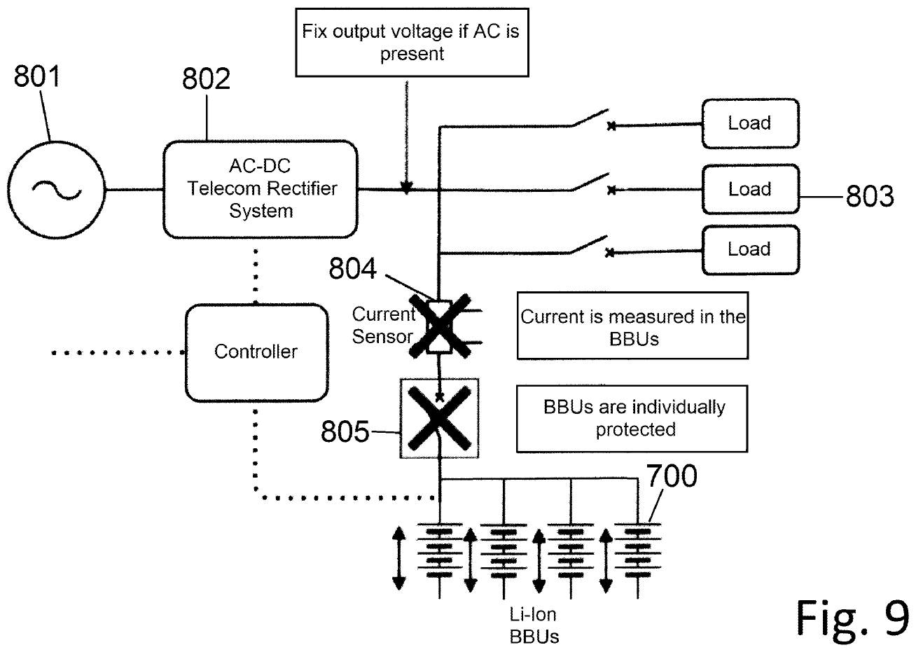

FIG. 9 shows a potential exemplary embodiment of a Telecom BBU system application. The Telecom BBU system is mainly powered by the AC voltage 801 going through rectifier 802 to supply a fixed DC voltage to the load 803. During the power trip/interruption from the main power AC voltage 801, the telecom BBU battery packs 700 supply power to the load 803. During the discharge phase, the voltage level may drop below the minimum-voltage required by the loads. In this case, the BBU battery packs 700 can boost the voltage to avoid the Telecom system's shutdown.

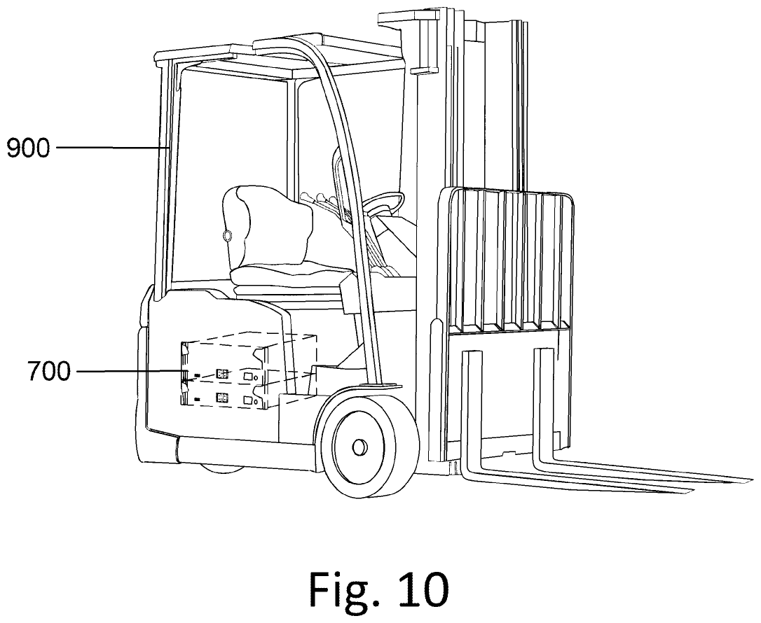

FIG. 10, shows another potential exemplary embodiment, using non-swappable battery packs 700 within material handling equipment 900 such as within a forklift, or other type of ground support equipment. In other embodiments, swappable battery packs 200 may also be utilized within similar material handling equipment 900 in combination with a remote-controlled charger 500 using a robot arm 501 (previously described with reference to FIG. 7).

Additionally, any of the battery charging station 100, swappable battery packs 200, non-swappable battery packs 700, and/or the remote-controlled charger 500 described herein may also include an artificial intelligence hub. In this embodiment, the artificial intelligence hub may be provided at the point of fulfillment to monitor the performance or efficiency of the battery packs, machines, and/or staff. This ability to monitor operations may also establish the foundation for future artificial intelligence software within the workplace. This artificial intelligence hub may also interact with workplace database(s) so the performance of the staff/equipment/machines can be monitored and/or improved.

Additionally, any of the battery charging station 100, swappable battery packs 200, non-swappable battery packs 700, and the remote-controlled charger 500 described herein may also include Wi-Fi, and/or Bluetooth Low Energy (BLE), and/or GPS, and/or a GPS locator therein (which may generally include other electronic components and/or a computer) to monitor data an/or interact with other equipment/machines. The Wi-Fi capability may allow the battery packs 200, or remote-controlled charger 500, to connect to the local network and/or to the battery charging stations 100. The BLE capability may communicate battery pack's 200 location within the workplace. The GPS may transmit the battery pack's 200 location and/or act as an anti-theft solution. The Wi-Fi capability may also be important for integrating the battery charging station 100, battery packs 200/700, and/or remote-controlled charger 500, with the customer's existing technology and software. The Wi-Fi may also help to monitor work progress and be used to communicate with the battery pack's 200/700 state of charge data and/or the other available battery packs in the charging station to be taken by the remote-controlled charger. The Wi-Fi, BLE, and GPS may also help to prevent theft of the battery 200/700, as its exact position can be monitored/tracked. If lost, the battery pack 200/700 may also be quickly found using the Wi-Fi, BLE, and/or GPS.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A swappable battery charging system, comprising:
a battery charging station having multiple battery charging ports, each battery charging port of the multiple battery charging ports configured to releasably receive a rechargeable battery pack therein;
at least one rechargeable battery pack positioned within at least one battery charging port of the battery charging station and connected in parallel to at least one other rechargeable battery pack positioned within at least one other battery charging port of the battery charging station; and
wherein the at least one rechargeable battery pack has its own battery management system and can independently control its own charging and discharging limits.

2. The system of claim 1, wherein the at least one other rechargeable battery pack has its own battery management system and can also independently control its own charging and discharging limits.

3. (canceled)

4. The system of claim 1, wherein the at least one rechargeable battery pack independently controls its maximum charging and discharging limits based upon a state of health or temperature, to extend its own operating life.

5. The system of claim 1, wherein the at least one rechargeable battery pack independently controls its maximum charging and discharging limits based upon impedance or current to avoid operating above its battery rating.

6. The system of claim 1, wherein the at least one rechargeable battery pack independently controls its maximum charging and discharging limits to control energy flow exchanged in parallel between itself at the at least one other rechargeable battery pack to achieve voltage equalization.

7. The system of claim 1, wherein the at least one rechargeable battery pack has a circuit to boost voltage to maintain an acceptable voltage level during high load applications, or when a voltage level is not sufficient to meet the high load application's voltage requirement.

8. The system of claim 1, wherein the battery charging station controls float voltage of the at least one rechargeable battery pack, and wherein the at least one rechargeable battery pack independently controls its own charging current.

9. (canceled)

10. (canceled)

11. (canceled)

12. (canceled)

13. (canceled)

14. A non-swappable battery charging system, comprising:
a plurality of battery packs connected in parallel having same or different capacity, wherein each battery pack of the plurality of battery packs has its own battery management system to independently control its own charging and discharging limits; and
a battery charger operably coupled to a power source and at least one battery pack of the plurality of battery packs, wherein the battery charger is configured to charge the plurality of battery packs and to control a float voltage of the plurality of battery packs to charge the plurality of battery packs in parallel.

15. (canceled)

16. (canceled)

17. The system of claim 14, wherein each battery pack of the plurality of battery packs can control its maximum charging and discharging limits based upon a state of health or temperature, to extend its operating life.

18. The system of claim 14, wherein each battery pack of the plurality of battery packs independently controls its maximum charging and discharging limits based upon impedance to avoid operating above its own battery rating.

19. The system of claim 14, wherein each battery pack of the plurality of battery packs independently controls its maximum charging and discharging limits to control exchanged energy flow to achieve voltage equalization across the plurality of battery packs in parallel.

20. The system of claim 14, wherein each battery pack of the plurality of battery packs has a circuit to boost voltage to maintain an acceptable voltage level during high load applications, or when a voltage level is not sufficient to meet the high load application's voltage requirement.

21. The system of claim 14, wherein each of the plurality of battery packs independently controls its own charging current.

22. (canceled)

23. (canceled)

24. A method for charging or discharging batteries in a battery charging system, comprising:
coupling a plurality of rechargeable battery packs together in parallel;
determining which of the plurality of rechargeable battery packs has either a lowest impedance or voltage, or a highest impedance or voltage; and
setting a charging strategy for each of the plurality of rechargeable battery packs individually to control maximum charging and discharging limits for at least one particular rechargeable battery pack of the plurality of the rechargeable battery packs to extend its operating life, and to provide voltage equalization and control energy flow among the plurality of rechargeable battery packs.

25. The method of claim 24, further comprising setting a float voltage for each of the plurality of rechargeable battery packs individually.

26. The method of claim 24, further comprising determining an age, temperature, or state of health (SoH) for each of the plurality of rechargeable battery packs.

27. The method of claim 24, wherein each battery pack of the plurality of rechargeable battery packs shares different amounts of current and delivers its max current in a constant supply.

28. The method of claim 24, wherein discharge current of the at least one particular rechargeable battery pack is limited to a value which is different than that of other battery packs of the plurality of the rechargeable battery packs to avoid depleting the at least one particular rechargeable battery pack over its rating.

29. The method of claim 24, wherein setting a charging strategy for each of the plurality of rechargeable battery packs individually simplifies a charging circuit and hardware requirements.

30. The method of claim 24, wherein a battery pack of the plurality of the rechargeable battery packs having a lowest voltage automatically receives maximum charging current from other rechargeable battery packs of the plurality of the rechargeable battery packs to control exchanged energy flow.

31.-34. (canceled)
